(19) United States
(12) Patent Application Publication
(10) Pub. No.: US 2025/0353689 A1
(43) Pub. Date: Nov. 20, 2025

(54) GRANULAR MATERIAL CONVEYANCE AND TRANSFER APPARATUS

(71) Applicant: THE UNIVERSITY COURT OF THE UNIVERSITY OF GLASGOW, Glasgow, Strathclyde (GB)

(72) Inventor: Gilles BAILET, Glasgow, Strathclyde (GB)

(21) Appl. No.: 19/130,452

(22) PCT Filed: Nov. 15, 2023
(86) PCT No.: PCT/EP2023/081959

§ 371 Date: May 15, 2025

(30) Foreign Application Priority Data
Nov. 16, 2022 (GB) 2217097.1
Nov. 16, 2022 (GB) 2217098.9

(51) Int. Cl. B65G 33/22; B65G 33/24

(52) U.S. Cl. CPC B65G 33/22; B65G 33/24; B65G 2201/042

(57) ABSTRACT

A granular material conveyance apparatus [100] comprises a discharge conduit [102] comprising a proximal end [102a] configured to receive granular material from a granular material source and a distal end [102b] separated from the proximal end [102a] along a longitudinal direction of the conduit [102]. The discharge conduit [102] is movable with respect to the granular material source. An end effector [110] is engaged externally with respect to the discharge conduit [102] so as to be translatable along the longitudinal direction of the discharge conduit [102]. The discharge conduit [102] further comprises a conveyor [106] configured to move the granular material along a conveyance path [108] disposed within the discharge conduit [102] from the proximal end [102a] towards the distal end [102b] of the discharge conduit [102]. The end effector [110] has an inlet [112] in communication with the conveyance path [108] at least at a plurality of positions of the end effector [110] with respect to the discharge conduit [102] to allow the granular material to be conveyed from the discharge conduit [102] and into the end effector [110]. Also disclosed is a method and apparatus for transferring granular material between a filling module [202] and a receiving module [204].

### FIELD OF THE INVENTION

The present invention relates to systems and methods for conveying granular material and to systems and methods of transferring granular material. Such systems are of particular, although not necessarily exclusive, interest for applications in microgravity environments.

### BACKGROUND

Granular material (or granular matter) is generally defined as a conglomeration or aggregate of macroscopic, individually solid particles. Granular materials feature in a range of industries, such as manufacturing, construction, food, pharmaceuticals and agriculture. Granular materials such as rice and wheat grains, beans, and lentils have particular commercial significance due to their high demand as staple foods. Fertilizers are typically produced in the form of dry pellets for ease of transportation, storage and application.

It is often necessary to keep granular material dry to maintain its quality and longevity for its intended purpose. For example, moisture ingress will increase the risk of microbial growth on food products and can lead to seeds germinating prematurely. More generally, contaminants can cause degradation of desirable characteristics of the granular material, thereby affect its useful properties. Example degradation can be chemical degradation, such as unwanted oxidation. In particular, it is typically desirable to preserve the chemical properties of building materials and medicines. However, avoiding contamination of granular material can be particularly difficult during its transportation and when transferring the granular material from one container to another.

Granular materials have a useful role in additive manufacturing or 3D printing technology. 3D printing filament can be made by heating thermoplastic granules and extruding the melted plastic to form a continuous filament. This filament-type feedstock is used in fused filament fabrication (FFF), which involves feeding the filament into a 3D printer which heats and deposits the filament material in layers. In contrast, fused granulate fabrication (FGF), sometimes known as “pellet printing”, involves feeding thermoplastic granules directly into a hopper of the 3D printer, which then heats and deposits the thermoplastic. As such, FGF-type printing does not require the intermediate step of forming a filament.

FGF is preferable in some circumstances to FFF because the filament in FFF is prone to breakage, entanglement and jamming. Additionally, FGF is better suited to manufacturing larger parts than FFF, due to FGF printers having a greater throughput [1].

However, both printing methods require replacement of the feedstock, either by changing the filament spool (FFF) or replenishing the pellet supply (FGF). In FFF, replacing the filament disrupts the printing process. Although FGF printers can be reloaded with pellets without stopping the printing process, by loading the pellets into a hopper in communication with the printer head, the reloading process encounters several problems. Firstly, loading the pellets into an open hopper is likely to introduce contaminants into the system which can degrade the quality of the feedstock. Additionally, the pellets are gravity fed from the hopper to a heater of the FGF printer, thus limiting its use to gravitational environments and requiring the hopper to be positioned above the other components of the printer.

Considering operations that may be carried out in space, it is preferred to reduce dependence on the resupply of spare parts and tools (for example) from Earth. Manufacturing such parts in space avoids the costs, time delays and safety risks associated with space transportation. Additive manufacturing technology offers considerable potential as a means for in-space manufacturing. As the raw building material for manufacturing the parts, only the feedstock must be supplied (or resupplied) to a 3D printer, which can remain in space to be operated as and when new parts are required. Notwithstanding this, the application of 3D printing technology is presented with a number of substantial problems associated with the extreme conditions of such an environment. Notably, granular materials (thermoplastic pellets) flow differently under microgravity than Earth's gravity. Also, the feedstock must be transported through a vacuum while experiencing large temperature changes, and contaminants such as moisture, corrosive gases and dust may damage the feedstock.

Therefore, in spite of the long-established and widespread commercial use of granular materials in various technical fields, the systems and apparatus for transporting granular materials which are currently available still encounter many problems. Additionally, the existing technology designed to convey granular material on Earth is not suitable for in-space manufacturing. The present invention has been devised in light of the above considerations.

### SUMMARY OF THE INVENTION

In the disclosure, we present different “developments” of the present invention, each comprising different optional aspects and further optional features. These are presented below as Development A and Development B.

### Development A

In a first aspect of Development A, the present invention provides a granular material conveyance apparatus, the apparatus comprising:
a discharge conduit comprising a proximal end configured to receive granular material from a granular material source and a distal end separated from the proximal end along a longitudinal direction of the conduit, wherein the discharge conduit is movable with respect to the granular material source,
an end effector engaged externally with respect to the discharge conduit so as to be translatable along the longitudinal direction of the discharge conduit,
wherein the discharge conduit further comprises a conveyor configured to move the granular material along a conveyance path disposed within the discharge conduit from the proximal end towards the distal end of the discharge conduit,
wherein the end effector has an inlet in communication with the conveyance path at least at a plurality of positions of the end effector with respect to the discharge conduit to allow the granular material to be conveyed from the discharge conduit and into the end effector.

In a second aspect of Development A, the present invention provides a method of conveying granular material using a granular material conveyance apparatus, the apparatus comprising:
a discharge conduit comprising a proximal end configured to receive granular material from a granular material source and a distal end separated from the proximal end along a longitudinal direction of the conduit, wherein the discharge conduit is movable with respect to the granular material source,
an end effector engaged externally with respect to the discharge conduit so as to be translatable along the longitudinal direction of the discharge conduit,
wherein the discharge conduit further comprises a conveyor configured to move the granular material along a conveyance path disposed within the discharge conduit from the proximal end towards the distal end of the discharge conduit,
wherein the end effector has an inlet in communication with the conveyance path at least at a plurality of positions of the end effector with respect to the discharge conduit to allow the granular material to be conveyed from the discharge conduit and into the end effector,

the method including the steps of operating the conveyor to move the granular material along the conveyance path disposed within the discharge conduit from the proximal end towards the distal end of the discharge conduit, and positioning the inlet of the end effector in communication with the conveyance path at least at a plurality of positions of the end effector with respect to the discharge conduit and conveying the granular material from the discharge conduit and into the end effector.

Advantageously, the granular material conveyance apparatus enables granular material to be conveyed from the granular material source to the end effector without movement of the granular material source in register with the end effector. Therefore, the apparatus can have a low moving mass associated with operating the end effector even while the end effector is moved and supplied with granular material simultaneously. This reduces internal torques and vibrations of the apparatus in operation, which is particularly beneficial in microgravity environments such as the International Space Station (ISS) where strong vibrations can interfere with experiments and cause structural damage to the spacecraft. The low moving mass also enables the end effector to be repositioned at high speed while receiving granular material and reduce the overall energy consumption of the apparatus.

Additionally, the granular material can be isolated from contaminants located outside the apparatus (e.g. dust, moisture, oxygen, oxidizers, liquids) while the granular material is conveyed by the apparatus.

Additionally, the capability for the discharge conduit to move relative to the granular material source provides at least two degrees of freedom of movement for the end effector with respect to the granular material source. The improves the operability of the end effector by providing a greater range of movement.

Optional features will now be set out. These are applicable singly, or in combination, with the first or second aspect of Development A.

In preferred embodiments, the inlet of the end effector is in communication with the conveyance path continuously during translation of the end effector along the longitudinal direction of the discharge conduit. For example, the discharge conduit may comprise an elongate slot extending between the proximal end and the distal end, the elongate slot configured to permit discharge of the granular material therethrough to the inlet.

The discharge conduit may extend linearly between the proximal end and the distal end. The discharge conduit may comprise a uniform diameter (internal and/or external diameter) along the longitudinal direction, e.g. the discharge conduit may be a cylindrical tube. The elongate slot may extend linearly between the proximal end and the distal end. The elongate slot may be formed in an underside of the discharge conduit. This may be of interest in particular where the apparatus is intended for use in normal gravity environments. The elongate slot may extend from the proximal end to the distal end of the discharge conduit.

The discharge conduit is movable with respect to the granular material source. For example, the discharge conduit may be translatable in a direction perpendicular to its longitudinal direction. Preferably the discharge conduit is movable in at least two spatial dimensions, e.g. three dimensions. The discharge conduit may be movable in a single plane.

Preferably, the discharge conduit comprises an adjustable barrier configured to prevent discharge of the granular material from the elongate slot at locations other than the location of the inlet of the end effector. The adjustable barrier may be configured to extend along the elongate slot of the discharge conduit. The adjustable barrier may be adjustable to vary the locations of the elongate slot from where discharge of the granular material is prevented. The adjustable barrier may limit discharge of the granular material exclusively to the location of the inlet of the end effector.

The adjustable barrier may be reversibly extendable with respect to the end effector. The adjustable barrier may comprise a curved surface which conforms to an outer surface or inner surface of the discharge conduit. The adjustable barrier may have a uniform cross-section perpendicular to the longitudinal direction. The adjustable barrier may be configured to form a seal with the discharge conduit.

The adjustable barrier may be disposed inside the discharge conduit. Typically this disposition will be such that it is clear of the conveyor. Alternatively, the adjustable barrier may be disposed outside the discharge conduit.

The adjustable barrier may comprise a tape. The tape may comprise metal (e.g. spring steel) and/or a polymer.

Alternatively, or additionally, the adjustable barrier may comprise a cover having a length variable in the longitudinal direction. The cover may comprise an elastic material. The cover may comprise a series of telescoping sections forming a telescoping linkage. The telescoping linkage may comprise overlapping cylindrical sections, each cylindrical section configured to partially, or completely, circumscribe a cross-section of the discharge conduit. Alternatively, or additionally, the cover may comprise a bellows.

The apparatus may comprise a first extension and retraction mechanism coupled to a first end of the adjustable barrier and configured to pay out and store the adjustable barrier along the longitudinal direction.

The apparatus may further comprise a second extension and retraction mechanism coupled to a second end of the adjustable barrier and configured to pay out and store the adjustable barrier along the longitudinal direction in concert with the first extension and retraction mechanism. The adjustable barrier may be configured to be coiled within the first and second extension and retraction mechanisms.

The first extension and retraction mechanism may be disposed at the proximal end of the discharge conduit. The second extension and retraction mechanism may be disposed at the distal end of the discharge conduit. Alternatively, both the first and second extension and retraction mechanisms may be disposed at the proximal end or the distal end of the discharge conduit. For example, the adjustable barrier may comprise a retroflexed portion at the distal end, wherein the adjustable barrier extends in the longitudinal direction along opposite sides of the discharge conduit from the retroflexed portion.

Optionally, the first and/or second extension and retraction mechanisms may comprise a reel-in mechanism configured to retract the adjustable barrier. The reel-in mechanism may comprise a wheel coupled to an end of the adjustable barrier, wherein the adjustable barrier is configured to wind and unwind around the wheel.

The reel-in mechanism may comprise a biasing element configured to bias the adjustable barrier towards a retracted configuration in which the extension and retraction mechanism stores the adjustable barrier. The first and second retraction and extension mechanisms may each comprise a biasing element mutually configured to apply an equal and opposite force to the adjustable barrier.

The first and/or second extension and retraction mechanisms may comprise an outer casing for housing the adjustable barrier.

As a result of the freedom of movement of the end effector and the freedom of movement of the discharge conduit, the end effector is movable in at least two dimensions with respect to the granular material source. The end effector may be movable in three dimensions with respect to the granular material source.

The end effector may be coupled to the discharge conduit via a slider movable in the longitudinal direction. The slider may be mounted to the outer surface of the discharge conduit, e.g. circumscribing the discharge conduit. The slider may be configured to align the inlet of the end effector to the elongate slot. For example, slider may be coupled to the adjustable barrier preventing rotation of the slider.

The slider may be engageable with the elongate slot. For example, the elongate slot may be defined by opposing longitudinal edges, wherein one or both longitudinal edges comprise a ridge portion. The slider may comprise one or more grooves, each groove configured to receive one of the ridge portions. Each longitudinal edge may comprise a groove for receiving a respective ridge portion of the slider. The grooves may be configured to provide a seal between the elongate slot and the slider.

The end effector may be pivotally coupled to the discharge conduit, e.g. the end effector may be pivotally coupled to the slider. The end effector may be rotatable about a rotation axis perpendicular to the longitudinal direction, the rotation axis coincident with the inlet.

In some embodiments, the discharge conduit is configured to receive granular material from the granular material source via a supply chamber having an outlet in communication with the proximal end of the discharge conduit and configured to contain granular material. The supply chamber may comprise a greater capacity for granular material than the discharge conduit, e.g. the supply chamber may be configured to hold not less than two times the capacity of the discharge conduit, e.g. not less than five times the capacity of the discharge conduit.

The outlet of the supply chamber may be disposed at a distal end of the supply chamber. The distal end of the supply chamber may be separated from a proximal end of the supply chamber along a second longitudinal direction. The supply chamber may comprise an upstanding conduit, e.g. a cylindrical tube. The cylindrical tube may comprise a greater diameter than that of the discharge conduit. In more general terms, the supply chamber may have a greater internal volume (i.e. capacity to store granular material) than the discharge conduit. For example, the internal volume of the supply chamber may be at least 2 time, at least 5 time or at least 10 times the internal volume of the discharge conduit.

The supply chamber may be movable in the second longitudinal direction. For example, the supply chamber may be supported by a movable platform. The platform may be movable in a direction perpendicular to the longitudinal direction.

The supply chamber may comprise a second conveyor configured to move the granular material along a second conveyance path from the proximal end of the supply chamber towards the distal end of the supply chamber. The second conveyance path may be disposed within the supply chamber. The conveyance path may be an extension of the second conveyance path.

The supply chamber may comprise an inlet for receiving granular material. The inlet may be disposed at the proximal end of the supply chamber.

The supply chamber may comprise a plurality of inlets. The apparatus may comprise a mixed feeding system wherein each inlet of the plurality of inlets is configured to receive a different type of granular material. The plurality of inlets may be used selectively in isolation or in combination with one or more of the other inlets of the plurality of inlets. The apparatus may comprise a plurality of auxiliary tanks corresponding to the plurality of inlets, wherein each inlet is configured to receive granular material from one of the auxiliary tanks of the plurality of auxiliary tanks.

The discharge conduit is preferably coupled to the supply chamber via a rotatable joint. The rotatable joint provides an intermediate stage between the supply chamber and the discharge conduit, i.e. the rotatable joint is configured in communication with both the proximal end of the discharge conduit and the outlet of the supply chamber. The rotatable joint is configured to permit swinging of the discharge conduit with respect to the supply chamber.

The rotatable joint may constrain the rotation of the discharge conduit to a single plane of rotation. The rotatable joint may comprise a rotation axis perpendicular to the longitudinal direction. Therefore, the plane of rotation may be defined as a sweepable area of the discharge conduit. The discharge conduit may be rotatable through a rotation angle not less than 90 degrees, e.g. not less than 120 degrees, 180 degrees, 270 degrees or 360 degrees. Alternatively, or additionally, a maximum rotation angle may be not more than 360 degrees, e.g. not more than 270 degrees, 180 degrees or 120 degrees.

The rotatable joint may comprise a revolute joint mounted to the supply chamber. The revolute joint may be a cylindrical joint mounted to the cylindrical tube of the supply chamber. The supply chamber may comprise a first bearing separating a peripheral wall of the supply chamber from the rotatable joint. The supply chamber may comprise a second bearing separating the rotatable joint from a lid portion. The first and/or second bearings may comprise an O-ring.

Preferably, the conveyer comprises an auger arrangement comprising an auger disposed within the discharge conduit. The auger may comprise a rotation axis parallel to the longitudinal direction configured to propagate the granular material along the conveyance path.

The auger arrangement may comprise a motor (e.g. a stepper motor) coupled to an end of the auger. The motor may be disposed at the proximal end of the discharge conduit. The motor may be configured to vary a rotation speed and/or direction of the auger. The rotation speed of the auger may be varied according to the demand of the end effector for granular material.

Preferably, the second conveyer comprises a second auger arrangement comprising a second auger disposed within the supply chamber. The second auger may comprise a rotation axis perpendicular to the longitudinal direction and configured to propagate granular material along the second conveyance path.

The second auger arrangement may comprise a second motor (e.g. stepper motor) coupled to an end of the second auger. The second motor may be disposed at the proximal or distal end of the supply chamber. The second motor may be configured to vary a rotation speed and/or direction of the second auger. The rotation speed of the second auger may be varied according to the demand of the end effector for granular material.

Alternatively, the second conveyor may comprise a pulse elevator or ultrasound elevator.

Alternatively, or additionally, one or both conveyors may comprise a vibratory conveyer configured to propagate the granular material along the first and/or second conveyance paths.

Alternatively, or additionally, one or both conveyors may comprise a pneumatic conveyor configured to supply compressed fluid into the apparatus at the proximal end of the discharge conduit or the proximal end of the supply chamber. The compressed fluid may comprise an inert gas, e.g. pure nitrogen.

The apparatus may comprise an actuator to control the movement of the end effector.

In some embodiments, the actuator may be directly coupled to the end effector to drive movement of the end effector. Accordingly, the apparatus may be passively adjustable to follow the position of the end effector.

Alternatively, the actuator may be configured to actively control the movement of the apparatus to adjust the position of the end effector. For example, one or both of the first and second extension and retraction mechanisms may comprise a drive motor (e.g. a stepper motor) coupled to the adjustable barrier and configured to vary the extension and retraction of the adjustable barrier.

The rotatable joint may comprise a second drive motor configured to vary the rotation angle of the discharge conduit. By controlling the longitudinal translation R of the end effector along the discharge conduit and the rotation angle θ of the discharge conduit with respect to the supply chamber, the position of the end effector can be easily mapped using 2D polar coordinates (R, θ).

The method of the second aspect may be carried out in a microgravity environment.

The end effector may comprise all or part of a 3D printing apparatus.

### Development B

Following from their work leading to Development A, the inventors have carried out further investigations and consider that their innovations in this technical field can additionally be expressed as a further development, here termed Development B. It is intended that any of the following aspects and/or further optional features can be combined, singly or in combination, with any of the aspects or optional features referred to with respect to Development A.

According to a first aspect of Development B, the present invention provides a method of transferring granular material between a filling module and a receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet is sealed and an open position in which the outlet is open to permit discharge of granular material from the transport chamber,
the method comprising steps of:
   coupling the filling module to the receiving module;
   moving the cover from the closed position to the open position; and
   operating the conveyor to transfer granular material between the transport chamber and the receiving module via the outlet.

According to a second aspect of Development B, the present invention provides a granular material transfer apparatus, the apparatus comprising a filling module and a receiving module, the filling module being configured to be received by the receiving module to transfer granular material between the filling module and the receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet from the transport chamber is sealed and an open position in which the outlet from the transport chamber is open to permit discharge of granular material from the transport chamber.

According to a third aspect of Development B, there is provided a system for handling granular material, the system comprising a granular material transfer apparatus and a granular material conveyance apparatus,

wherein the granular material transfer apparatus comprising a filling module and a receiving module, the filling module being configured to be received by the receiving module to transfer granular material between the filling module and the receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet from the transport chamber is sealed and an open position in which the outlet from the transport chamber is open to permit discharge of granular material from the transport chamber,

and wherein the granular material conveyance apparatus comprises:
a discharge conduit comprising a proximal end configured to receive granular material from a granular material source and a distal end separated from the proximal end along a longitudinal direction of the conduit,
an end effector engaged externally with respect to the discharge conduit so as to be translatable along the longitudinal direction of the discharge conduit,
wherein the discharge conduit further comprises a conveyor configured to move the granular material along a conveyance path disposed within the discharge conduit from the proximal end towards the distal end of the discharge conduit,
wherein the end effector has an inlet in communication with the conveyance path at least at a plurality of positions of the end effector with respect to the discharge conduit to allow the granular material to be conveyed from the discharge conduit and into the end effector,

and wherein the granular material source for the granular material conveyance apparatus is provided by the receiving module of the granular material transfer apparatus.

Optional features will now be set out. These are applicable singly, or in combination, with the any of the first, second and/or third aspects of Development B.

Advantageously, the method and apparatus for transferring granular material between a filling module and a receiving module preserves a controlled environment for the granular material during transfer. In particular, coupling the filling module to the receiving module and moving the cover from the closed position to the open position enables the granular material to be isolated from the external environment outside of the filling module and the receiving module. Contamination of the granular material is thus avoided, even while the granular material is transferred between different vessels. Furthermore, loss of granular material is avoided.

In some embodiments, the transport chamber may have a peripheral wall surrounding the conveyance path. The transport chamber may comprise a proximal end and a distal end, e.g. the distal end being separated from the proximal end in a longitudinal direction. The peripheral wall may extend between the proximal and distal ends of the transport chamber. The peripheral wall may extend linearly, wherein the longitudinal direction is parallel to a longitudinal axis of the transport chamber. The transport chamber may have a uniform cross-section along the longitudinal direction. For example, the transport chamber may be a cylindrical tube.

The outlet may be formed in the peripheral wall of the transport chamber, e.g. the outlet may be defined by a gap in the peripheral wall. The gap may extend between transverse cross-sections of the transport chamber perpendicular to the longitudinal direction.

The filling module may comprise a shaft extending in the longitudinal direction within the transport chamber. The shaft may define the longitudinal axis of the transport chamber. The shaft may be fixed in the longitudinal direction relative to the peripheral wall (i.e. movement of the transport chamber in the longitudinal direction involves moving the peripheral wall and the shaft jointly). The shaft may be rotatable relative to the peripheral wall about the longitudinal axis.

The filling module may comprise an end cap. The outlet may be partially defined by the end cap. The end cap may be resiliently deformable. The end cap may be an axial end cap arranged at the distal end of the transport chamber. The axial end cap may comprise an annular flange projecting radially outward from the shaft. The axial end cap may extend in a plane perpendicular to the longitudinal axis.

The end cap may be integrally formed with the shaft. Alternatively, the end cap may be rotatably coupled to the shaft, e.g. the end cap may comprise a rotation axis coincident with the longitudinal axis.

The end cap may comprise a cross-section perpendicular to the longitudinal axis which converges in the longitudinal direction, e.g. forwards of the transport chamber. For example, the end cap may comprise a nose portion. The nose portion may be convex. The nose portion may be conical-shaped.

Moving the cover between the open position and the closed position may involve moving the cover in the longitudinal direction. The cover may be movable with respect to the end cap, e.g. the cover may form a seal with the end cap in the closed position.

Preferably, the cover comprises a sleeve movable with respect to the peripheral wall of the transport chamber. The sleeve may be moved from the open position to the closed position by retracting the sleeve away from the end cap to uncover the outlet.

The sleeve is preferably an outer sleeve. The filling module may comprise an inner sleeve movable relative to the outer sleeve. The inner sleeve may be provided by the peripheral wall of the transport chamber. The outer sleeve may be configured to overlap a section of the peripheral wall, e.g. the peripheral wall and the outer sleeve may be configured to provide an interference fit.

In other embodiments, the cover may comprise a plurality of telescoping sections forming a telescoping linkage. The telescoping linkage may comprise overlapping cylindrical sections, each cylindrical section configured to circumscribe the transport chamber for covering the outlet in the peripheral wall when in the closed position.

Alternatively, or additionally, the cover may comprise a bellows configured to circumscribe the transport chamber for covering the outlet in the peripheral wall in the closed position.

In preferred embodiments, the step of coupling the filling module to the receiving module causes movement of the cover from the closed position to the open position. The step of moving the cover from the closed position to the open position may comprise relative movement between the filling module and the receiving module.

The sleeve may comprise an annular flange which extends inwardly from the sleeve towards the longitudinal axis at the distal end of the transport chamber. The annular flange may overlap a distal edge of the peripheral wall, e.g. the distal edge may abut the annular flange in the open position. The annular flange may circumscribe the shaft (e.g. the auger). An inner diameter of the annular flange may be greater than an outer diameter of the auger. The inner diameter of the annular flange may be less than an outer diameter of the end cap. The annular flange may abut the end cap in the closed position. For example, the annular flange may provide an interface between the peripheral wall and the end cap. The annular flange may comprise a cross-section perpendicular to the longitudinal axis which converges in the longitudinal direction, e.g. towards the distal end. For example, the annular flange may be frustoconical-shaped.

The filling module may comprise a biasing element configured to bias the cover towards the closed position. Moving the cover from the closed position to the open position may therefore resist the biasing force of the biasing element. The biasing element may comprise a compression spring, the spring having a first end coupled to the cover and a second end coupled to the transport chamber. The compression spring may be coiled around the peripheral wall of the transport chamber, e.g. the compression spring may comprise a central axis coincident with the longitudinal axis. Alternatively, the biasing element may comprise a compliant mechanism.

The filling module may comprise a plurality of biasing elements, e.g. a plurality of compression springs, configured to bias the cover towards the closed position. Each compression spring of the plurality of compression springs may comprise a first end coupled to the cover and a second end coupled to the transport chamber. Each compression spring of the plurality of compression springs may comprise a central axis parallel to the longitudinal axis. For example, the plurality of compression springs may be arranged adjacent the peripheral wall of the transport chamber, e.g. equidistant from the other compression springs.

In some embodiments, the filling module may comprise a path for guiding movement of the transport chamber, e.g. during the step of coupling the filling module to the receiving module. The path may be defined by a guide rail wherein the transport chamber is mounted to the guide rail. The path may be a linear path, e.g. arranged parallel to the longitudinal direction.

The guide rail may be slidably coupled to the transport chamber. For example, the filling module may comprise a slider rigidly coupled to the transport chamber and slidably coupled to the guide rail. The guide rail may comprise an actuator for controlling the movement of the slider. The actuator may comprise a track configured to engage the slider. The guide rail may comprise a motor for driving movement of the track to vary the position of the slider.

In other embodiments, the transport chamber may be freely movable during the step of coupling the filling module to the receiving module (i.e. without a predefined path). For example, the transport chamber may be transported manually, e.g. by hand. The transport chamber may be transported using a vehicle controlled remotely and/or locally. Alternatively, or additionally, the transport chamber may be controlled using a robotic arm.

Preferably, the conveyer comprises an auger arrangement comprising an auger disposed within the transport chamber. The auger may comprise a rotation axis parallel to the longitudinal direction and configured to propagate the granular material along the conveyance path. The rotation axis may be coincident with the longitudinal axis of the transport chamber.

The auger may be integrally formed with the shaft, e.g. the end cap may be coupled to the auger at the distal end of the transport chamber. The end cap may rotate with the auger about the rotation axis of the auger e.g. the end cap may be integrally formed with the auger. Alternatively, the end cap may be rotatably coupled to the auger, e.g. the end cap may comprise a rotation axis coincident with the rotation axis of the auger and the end cap may rotate freely with respect to the auger.

The auger arrangement may comprise a motor (e.g. a stepper motor) coupled to an end of the auger. The motor may be disposed at the proximal end of the transport chamber. The motor may be configured to vary a rotation speed and/or direction of the auger.

The auger arrangement may comprise a first rotation direction configured to convey the granular material within the transport chamber towards the outlet, e.g. to discharge the granular material from the transport chamber. The auger arrangement may comprise a second rotation direction configured to convey the granular material within the transport chamber away from the outlet, e.g. to extract granular material from outside the transport chamber.

Alternatively, or additionally, the conveyor may comprise a vibratory conveyer (e.g. an ultrasonic actuator) configured to propagate the granular material along the conveyance path.

Alternatively, or additionally, the conveyor may comprise a pneumatic conveyor, e.g. configured to supply compressed fluid into the transport chamber to discharge granular material into the receiving module. The pneumatic conveyer may be configured to supply compressed fluid into the receiving module to extract granular material from the receiving module. The compressed fluid may comprise an inert gas, e.g. pure nitrogen.

Alternatively, or additionally, the conveyor may comprise a piston having a drive shaft parallel to the longitudinal direction and configured to drive the granular material along the conveyance path.

The step of coupling the filling module to the receiving module may comprise fitting the end cap of the filling module to a complementary port on the receiving module.

The complementary port may comprise an aperture defined by an outer rim. The outer rim may be configured to abut the annular flange of the sleeve e.g. to provide a continuous seal therebetween. For example, the outer rim may comprise a frustoconical interior surface.

The complementary port on the receiving module may be moveable between a closed position in which the receiving module is sealed and an open position in which the receiving module is capable of receiving granular material from the filling module.

The complementary port on the receiving module may be moved to the open position by the relative movement between the filling module and the receiving module. The open position of the filling module may correspond to the open position of the receiving module and the closed position of the filling module may correspond to the closed position of the receiving module. The aperture may comprise an inner diameter not less than the outer diameter of the end cap. The relative movement may comprise the end cap extending into the receiving module. The conveyor may partially extend into the receiving module with the end cap in the open position.

In some embodiments, the complementary port comprises a plug for sealing the aperture in the closed position. The complementary port may be formed in a front wall of the receiving module and the plug may be configured to abut the front wall in the closed position.

In some embodiments, the plug may be disposed within the receiving module and the plug is movable inwardly towards the open position, e.g. away from the front wall. The plug may comprise a shaft extending along a plug axis normal to the aperture. The plug may be movable along a linear path, e.g. normal to the aperture.

The movement of the end cap extending into the receiving module may displace the plug from its closed position. The plug axis may be parallel to the longitudinal direction during the step of coupling the filling module to the receiving module, e.g. the plug may be movable in the longitudinal direction.

The plug may comprise a front surface exposed to the outside of the receiving module in the closed position. The front surface may be configured to abut the end cap during the step of coupling the filling module to the receiving module. The front surface of the plug may be concave. For example, the front surface may comprise a recess, e.g. a conical recess.

The method may further comprise decoupling the filling module from the receiving module. Preferably, decoupling the filling module from the receiving module causes movement of the cover from the open position to the closed position to seal the outlet of the filling module. For example, the receiving module may comprise a biasing element configured to bias the plug towards the closed position.

The plug may be coupled to an inner wall of the receiving module, e.g. a rear wall opposite the front wall. The biasing element of the receiving module may comprise a spring coupled to the plug and the inner wall. The spring may be a compression spring arranged between the plug and the rear wall.

In some embodiments, the receiving module comprises an outlet for permitting discharge of the granular material from the receiving module. The receiving module outlet may be formed in a side wall of the receiving module e.g. extending between the front wall and the rear wall. The receiving module outlet may be arranged perpendicularly with respect to the complementary port. The plug may be movable clear of the receiving module outlet in the open position. For example, the receiving module outlet may be configured opposite the conveyor in the open position.

The receiving module may be mountable to an external vessel other than the filling module, e.g. for transferring granular material between the receiving module and the external vessel. The granular material may be transferable between the receiving module and the external vessel via the receiving module outlet.

The invention includes the combination of the aspects and preferred features described except where such a combination is clearly impermissible or expressly avoided.

Further optional features of the invention are set out below.

### SUMMARY OF THE FIGURES

Embodiments and experiments illustrating the principles of the invention will now be discussed with reference to the accompanying figures in which:

FIG. 1 is an exploded view of an exemplary granular material conveyance apparatus according to an embodiment of the invention.

FIG. 2 shows a schematic side view of the granular material conveyance apparatus.

FIG. 3 shows front cross sectional view of the discharge conduit and the adjustable barrier according to an embodiment of the invention.

FIG. 4 shows side cross sectional view of the discharge conduit according to an embodiment of the invention.

FIG. 5 shows a front cross sectional view of the discharge conduit and the end effector according to another embodiment of the invention.

FIG. 6 is an exploded view of an exemplary granular material transfer apparatus according to an embodiment of the invention.

FIG. 7 is a side cross sectional view of the granular material transfer apparatus with the cover configured in the closed position.

FIG. 8 is a side cross sectional view of the granular material transfer apparatus with the cover configured in the open position.

FIG. 9 is a side view of the granular material transfer apparatus before or after the filling module is coupled to the receiving module.

FIG. 10 is a side view of the granular material transfer apparatus when the filling module is coupled to the receiving module.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

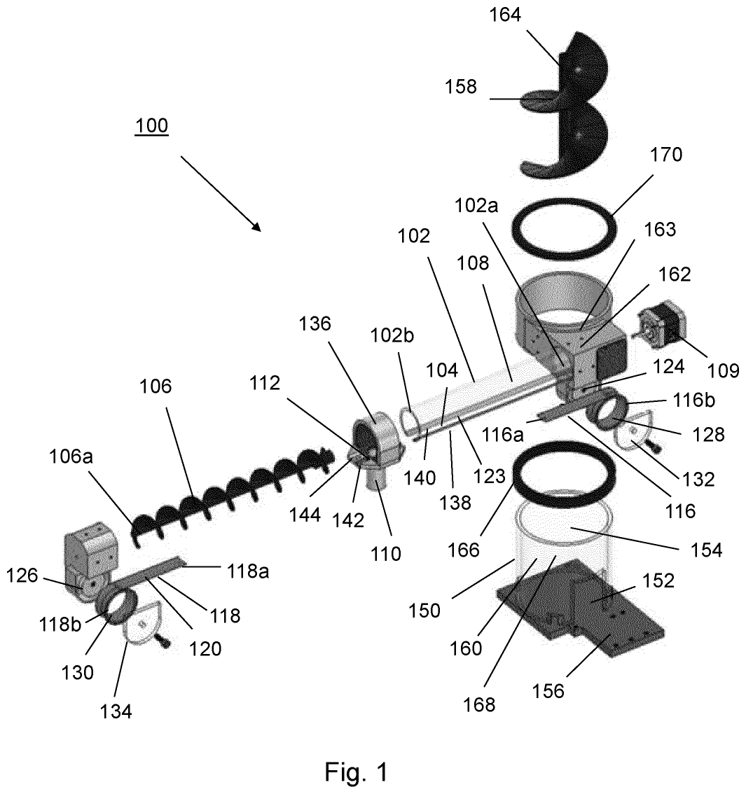

FIGS. 1-5 show an exemplary granular material conveyance apparatus 100 according to an embodiment of the invention.

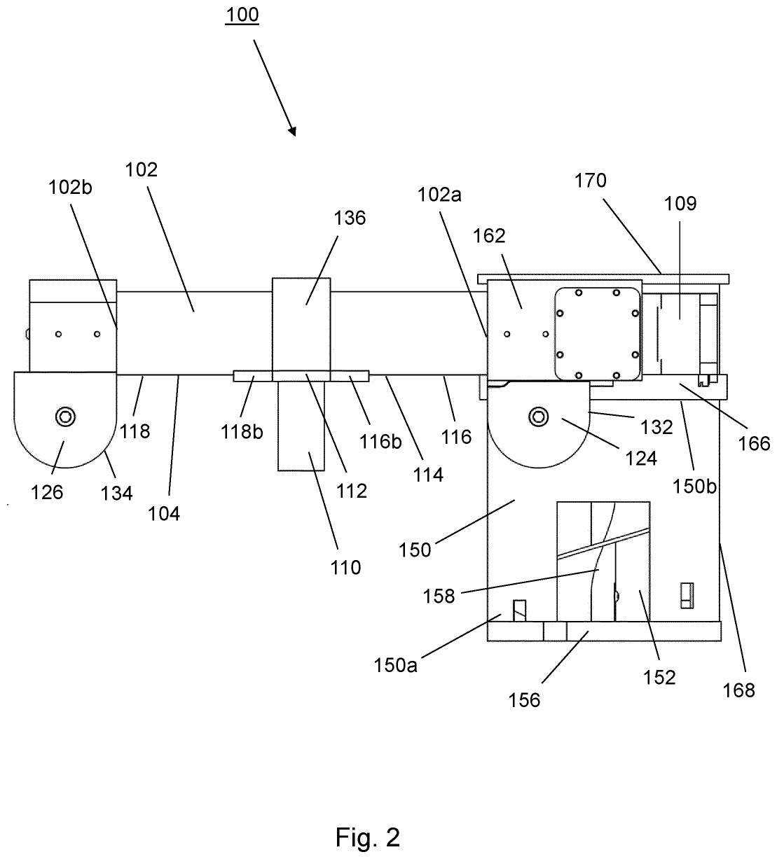

FIG. 1 is an exploded view of the granular material conveyance apparatus 100 illustrating constituent parts of the apparatus 100. FIG. 2 shows a schematic side view of the granular material conveyance apparatus 100.

The apparatus 100 comprises a discharge conduit 102 having a proximal end 102a and a distal end 102b separated along a longitudinal direction. The discharge conduit 102 is a cylindrical tube having an elongate slot 104 formed therein, the elongate slot 104 extending linearly along the longitudinal direction and disposed in an underside of the discharge conduit 102.

The apparatus 100 comprises a first conveyor 106 provided by an auger configured to convey granular material (not shown) along a conveyance path 108 from the proximal end 102a towards the distal end 102b within the discharge conduit 102. The auger 106 is rotatable about a rotation axis 106a configured parallel to the longitudinal direction. The auger 106 is coupled to a stepper motor 109 (manufacturer part number: 17HS4401) [see Reference 2] disposed at a proximal end 102a of the discharge conduit 102.

The apparatus 100 comprises an end effector 110 engaged externally to the discharge conduit 102, the end effector 110 having an inlet 112 in continuous communication with the conveyance path 108 via the elongate slot 104 during translation of the end effector 110 along the longitudinal direction of the discharge conduit 102. Accordingly, the elongate slot 104 is configured to permit discharge of the granular material therethrough to the inlet 112 of the end effector 110.

The apparatus 100 further comprises an adjustable barrier 114 configured to prevent discharge of the granular material from the elongate slot 104 at locations other than the inlet 112 of the end effector 110. Accordingly, the discharge conduit 102 can only discharge granular material into the end effector 110.

In this embodiment, the adjustable barrier 114 is a reversibly extendable spring tape comprising a first section 116 arranged between the end effector 110 and the proximal end 102a, and a second section 118 arranged between the end effector 110 and the distal end 102b. The first and second sections 116, 118 of the spring tape 114 each comprise a first end 116a, 118a coupled to opposite sides of the end effector 110 which is configured therebetween.

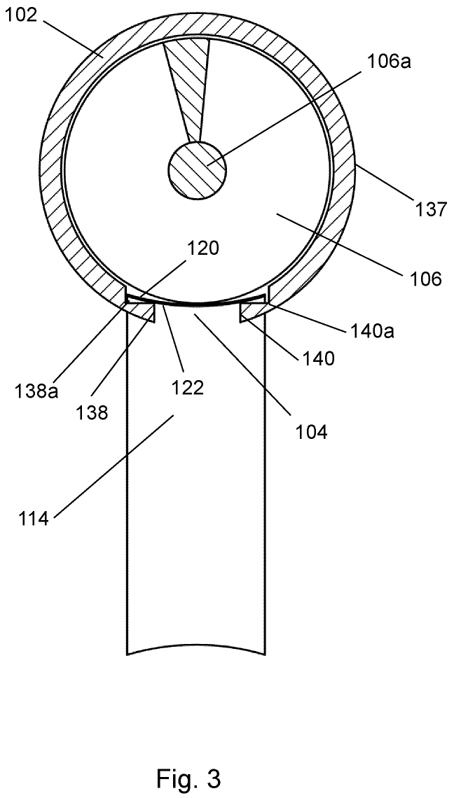

FIG. 3 shows front cross sectional view of the discharge conduit 102 and part of the spring tape 114 with the housing of the extension and retraction mechanism omitted and therefore the spring tape 114 shown both in cross section in the slot and in plan view. When located in the slot, the spring tape 114 comprises a concavely curved upper surface 120 for clearing a profile of the auger 106. The spring tape 114 also comprises a convexly curved lower surface 122 to conform to an inner surface 123 of the discharge conduit 102 proximate the elongate slot 104, thereby forming a seal with the discharge conduit 102.

As shown in FIGS. 1, 2 and 4, the apparatus 100 further comprises a first extension and retraction mechanism 124 disposed at the proximal end 102a and coupled to a second end 116b of the first section 116 of the spring tape 114. The first extension and retraction mechanism 124 is configured to pay out and store the first section 116 of the spring tape 114 along the longitudinal direction. A second extension and retraction mechanism 126 disposed at the distal end 102b is coupled to a second end 118b of the second section 118 of the spring tape 114. The second extension and retraction mechanism 126 is configured to pay out and store the second section 118 of the spring tape 114 along the longitudinal direction.

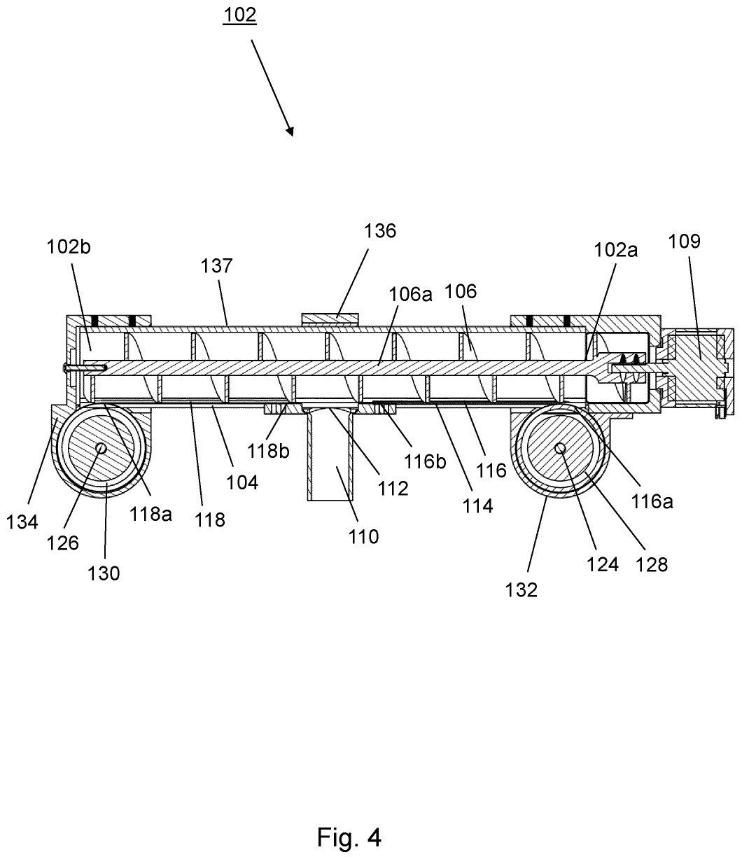

FIG. 4 shows a side cross sectional view of the discharge conduit 102 illustrating the extension and retraction mechanisms 124, 126 at the proximal 102a and distal 102b ends of the discharge conduit 102. The first and second extension and retraction mechanisms 124, 126 each comprise a wheel 128, 130 coupled to the second ends 116b, 118b respectively. The first and second sections 116, 118 of the spring tape 114 are configured to wind around the respective wheels 128, 130 when retracted. The first and second sections 116, 118 of the spring tape 114 are configured to unwind from the respective wheels 128, 130 when extended.

The first and second retraction and extension mechanisms 124, 126 are mutually configured to apply an opposing retraction force to the spring tape 114 and therefore the end effector 110 in the longitudinal direction. Each extension and retraction mechanism 124, 126 comprises an outer casing 132, 134 for housing the wheels 128, 130 and the first and second sections 116, 118 of the spring tape 114 respectively.

The end effector 110 is slidably coupled to the discharge conduit 102 via a slider 136 movable in the longitudinal direction. The end effector 110 is pivotally coupled to the slider 136 and rotatable about a rotation axis coincident with the inlet 112 and perpendicular to the longitudinal direction. The slider 136 is mounted to and circumscribes an outer surface 137 of the discharge conduit 102. The slider 136 is configured to align the inlet 112 of the end effector 110 to the elongate slot 104 and prevent rotation of the slider 136 by its engagement with the elongate slot 104.

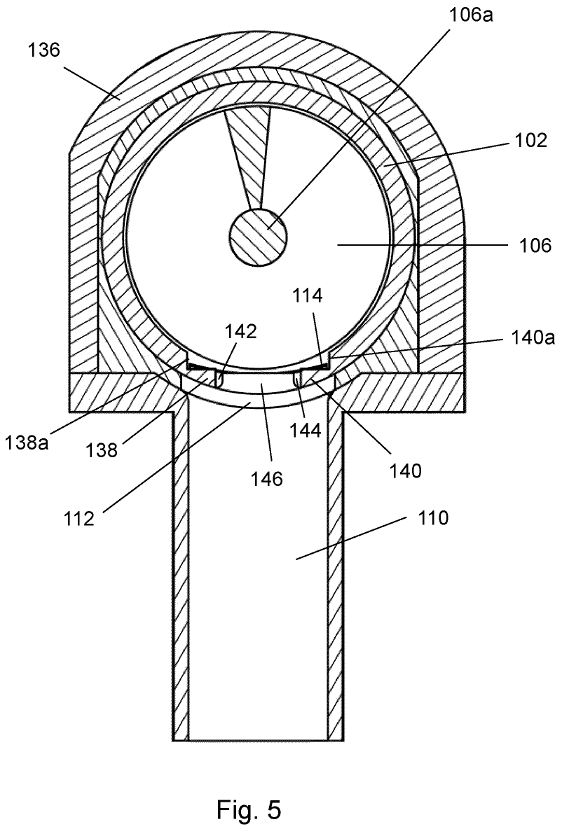

FIG. 5 shows a front cross sectional view of the discharge conduit and the end effector. As shown in FIGS. 4 and 5, the elongate slot 104 is defined by opposing longitudinal edges 138 and 140 each comprising a groove 138a and 140a. The slider 136 shown in FIG. 5 comprises longitudinal grooves 142, 144 configured to receive the longitudinal edges 138 and 140. The slider 136 comprises a central platform 146 partially defined by each longitudinal groove 142, 144 of the slider 136. The central platform 146 is disposed between the longitudinal edges 138, 140 of the elongate slot and arranged flush with the grooves 138a and 140a of the discharge conduit 102. The longitudinal grooves 142, 144 are configured to form a seal with the longitudinal edges 138 and 140.

The inlet 112 is formed in the central platform 146 and extends perpendicularly to the longitudinal direction. The lower surface 122 of the spring tape 114 is mounted on the central platform 146 and spring tape 114 is received by the grooves 138a, 140a of the longitudinal edges 138, 140 of the elongate slot 104. The first end 116a of the first section 116 of the spring tape 114 is coupled to the central platform 146 clear of the inlet 112. The first end 118a of the second section 118 of the spring tape 114 is also coupled to central platform 146 clear of the inlet 112 and is configured diametrically opposite the first end 116a of the first section 116.

As shown in FIGS. 1 and 2, the apparatus 100 comprises a supply chamber 150 comprising an upstanding cylindrical tube/conduit having a proximal end 150a separated from a distal end 150b along a second longitudinal direction. The discharge conduit 102 is configured to receive granular material from the granular material source via the supply chamber 150. The supply chamber 150 comprises an inlet 152 for receiving granular material from the granular material source. The inlet 152 is disposed at the proximal end 150a of the supply chamber 150. The supply chamber 150 comprises an outlet 154 disposed at the distal end 150b of the supply chamber 150, the outlet 154 in continuous communication with the proximal end 102a of the discharge conduit 102. The supply chamber 150 has a greater diameter and a greater overall capacity than the discharge conduit 102 for storing granular material.

The supply chamber 150 is supported by a platform 156. In some embodiments, the platform 156 is movable back and forth in the second longitudinal direction to vary the height of the apparatus 100 and therefore vary a vertical position of the end effector 110.

The supply chamber 150 comprises a second conveyor 158 provided by a second auger disposed within the supply chamber 150. The second auger 158 is rotatable about a second rotation axis 164 perpendicular to the longitudinal direction (i.e. parallel to the second longitudinal direction) to move the granular material along a second conveyance path 160 within the supply chamber 150 from the proximal end 150a of the supply chamber 150 towards the distal end 150b of the supply chamber.

The discharge conduit 102 is coupled to the supply chamber 150 via a rotatable joint 162. The rotatable joint 162 is configured in continuous communication with both the proximal end 102a of the discharge conduit 102 and the outlet 154 of the supply chamber 150. The rotatable joint 162 therefore provides an intermediate stage between the supply chamber 150 and the discharge conduit 102 connecting the second conveyance path 160 to the conveyance path 108.

The rotatable joint 162 is a revolute joint (a cylindrical joint) mounted to the distal end 150b of the supply chamber 150 comprising a rotation axis 164 perpendicular to the longitudinal direction. The rotatable joint 162 permits swinging of the discharge conduit 102 with respect to the supply chamber 150, which enables the end effector 110 to move with at least two degrees of freedom with respect to the supply chamber 150. The rotatable joint 162 is configured to constrain the rotation of the discharge conduit 102 to a single plane of rotation perpendicular to the second longitudinal direction and coincident with the longitudinal direction. The plane of rotation corresponds to sweepable area of the discharge conduit 102. The discharge 102 conduit is rotatable through a rotation angle not less than 90 degrees. The discharge conduit 102 extends substantially tangentially from a circumferential surface of the rotatable joint 162.

The supply chamber 150 comprises a first bearing 166 separating a peripheral wall 168 of the supply chamber 150 from the rotatable joint 162. The supply chamber 150 comprises a second bearing 170 that separates the rotatable joint 162 from a lid portion (not shown) of the supply conduit 150.

An actuator (not shown) may be directly coupled to the end effector 110 to drive movement of the end effector 110. Accordingly, the apparatus 100 is passively adjustable to follow the position of the end effector 110 during operation.

In other embodiments, the actuator may be configured to actively control the movement of the apparatus 100 to adjust the position of the end effector 110. Specifically, the first and/or second extension and retraction mechanisms 128, 130 may comprise a drive motor (not shown) coupled to the spring tape 114 (e.g. to the first section 116 and/or the second section 118) to vary the extension and retraction of the spring tape 114.

In other embodiments, the inlet 152 may be one of a plurality of inlets (not shown), wherein each inlet of the plurality of inlets is configured to receive a different type of granular material. The plurality of inlets may be configured to receive granular material from a plurality of auxiliary tanks (not shown).

The apparatus 100 may be operated by simultaneously driving the rotation of the augers 106, 158 to convey granular material from the inlet 152 of the supply chamber 150 to the end effector 110.

Meanwhile, the end effector 110 is free to move in a 2D plane with respect to the supply chamber 150 to discharge granular material therefrom.

The granular material may comprise thermoplastic pellets (not shown) and the end effector 110 may comprise a heater arrangement of an FGF 3D printing device (not shown) having a nozzle and an extrusion screw therein for compressing and mixing the thermoplastic pellets into melted thermoplastic which is subsequently extruded from the nozzle. The apparatus 100 can therefore convey the thermoplastic pellets to the nozzle in an isolated environment to avoid contamination of the thermoplastic pellets. Additionally, the granular material source is stationary with respect to the end effector 110. This reduces the moving mass of the apparatus 100 as compared to conventional FGF printers in which the granular material source (hopper) is required to move with the nozzle. The lower moving mass reduces vibrations and internal torques of the apparatus 100, which significantly improves printing quality. In further contrast with conventional FGF printers, the apparatus 100 does not rely on the assistance of gravity to convey granular material to the end effector 100. This makes the apparatus 100 particularly well-suited to applications in microgravity environments.

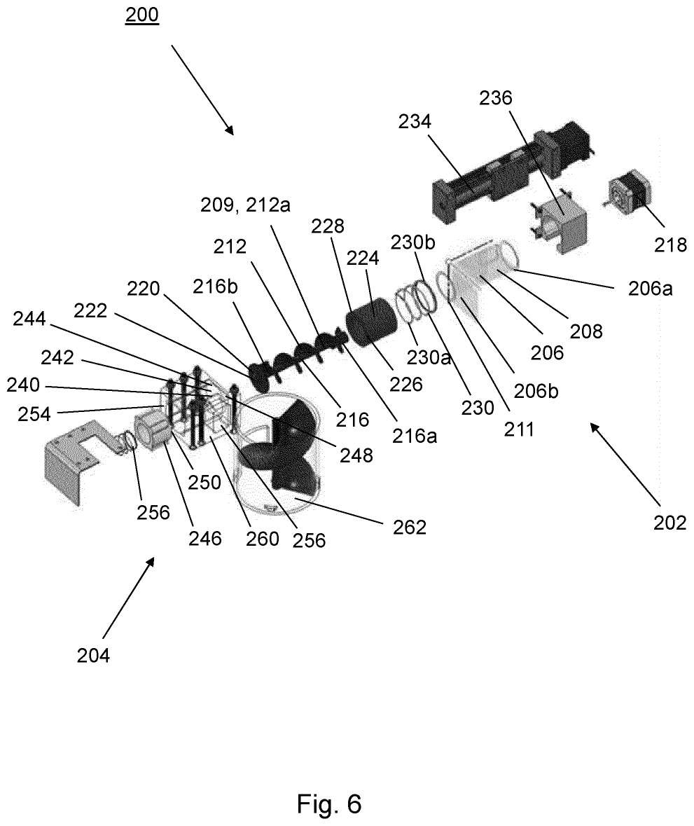

As part of their work to overcome the technical problems associated with conveying granular material, the inventor has also developed a method of conveying granular material by transferring granular material between separate vessels. FIGS. 6-10 show a preferred embodiment of the invention which provides a granular material transfer apparatus 200 for implementing this method. As will be understood, this apparatus can be used either individually or together with the conveyance apparatus described above in order to form a system for handling granular material according to a further embodiment of the invention.

FIG. 6 is an exploded view of the granular material transfer apparatus 200. The apparatus 200 comprises a filling module 202 and a receiving module 204 configured to be coupled together to transfer granular material (not shown) between the filling module 202 and the receiving module 204. In the overall system, the receiving module may be, or may in communication with, the granular material supply chamber described with respect to the conveyance apparatus set out above.

The filling module 202 comprises a transport chamber 206 configured to store granular material. The transport chamber 206 comprises a proximal end 206a and a distal end 206b. The distal end 206b is separated from the proximal end 206a by a peripheral wall 208 which extends linearly in a longitudinal direction. The longitudinal direction is therefore parallel to a longitudinal axis 209 of the transport chamber 206. The transport chamber 206 is a cylindrical tube having a uniform cross-section in the longitudinal direction.

The filling module 202 comprises an outlet 210 formed in the peripheral wall 208 of the transport chamber 206. The outlet 210 is defined by an annular gap which extends between transverse cross-sections of the transport chamber 206 perpendicular to the longitudinal direction from a circumferential edge 211 of the peripheral wall 208 to the distal end 206b of the transport chamber 206.

The filling module 202 comprises a conveyor 212 provided by an auger disposed in the transport chamber 206 and configured to move the granular material along a conveyance path 214 towards the outlet 210 of the transport chamber 206. The auger 212 has a rotation axis 212a coincident with the longitudinal axis 209 (parallel to the longitudinal direction) and configured to propagate the granular material along the conveyance path 214 as the auger 212 rotates.

The filling module 202 comprises a shaft 216 integrally formed with the auger 212, the shaft 216 defining the rotation axis 212a (i.e. the longitudinal axis 209 of the transport chamber 206). The shaft 216 and therefore the auger 212 are fixed in the longitudinal direction relative to the peripheral wall 208 such that any movement of the transport chamber in the longitudinal direction involves the peripheral wall 208 and the shaft 216 moving jointly in the longitudinal direction. Meanwhile the shaft 216 is able to rotate about the rotation axis 212a relative to the peripheral wall 208.

The filling module 202 comprises a stepper motor 218 coupled to a first end 216a of the shaft 216 disposed at the proximal end 206a of the transport chamber 206. The motor 218 is configured to vary a rotation direction of the auger 212 between a first rotation direction and a second rotation direction. The first rotation direction is configured to convey the granular material within the transport chamber 206 towards the outlet 210 to discharge the granular material from the transport chamber 206. The second rotation direction is configured to convey the granular material within the transport chamber 206 away from the outlet 210 to extract granular material from outside the transport chamber 206.

The filling module 202 further comprises an end cap 220 arranged at the distal end 206b of the transport chamber 206 which comprises an annular flange projecting radially outward from a second end 216b of the shaft 216. The end cap 220 extends in a plane perpendicular to the longitudinal/rotation axis 209, 212a. The end cap 220 is integrally formed with the shaft 216 such that the end cap 220 rotates with the auger about the rotation axis 212a of the auger.

The end cap 220 comprises a cross-section perpendicular to the longitudinal axis which converges in the longitudinal direction forwards of the transport chamber 206 to define a nose portion 222. The nose portion 222 is conical-shaped, which assists coupling the filling module 202 to the receiving module 204. The end cap 220 is made of a polymer having a low coefficient of friction so that the end cap 220 and the nose portion 222 can slide over contact surfaces of the receiving module 204 when the filling module 202 and the receiving module 204 are coupled together.

The filling module 202 comprises a cover 224 disposed with respect to the transport chamber 206. The cover 224 is provided by an outer sleeve configured to overlap the peripheral wall 208 at the distal end 206b of the transport chamber 206. The peripheral wall 208 therefore acts as an inner sleeve such that the outer sleeve 224 and the peripheral wall 208 are configured to provide an interference fit.

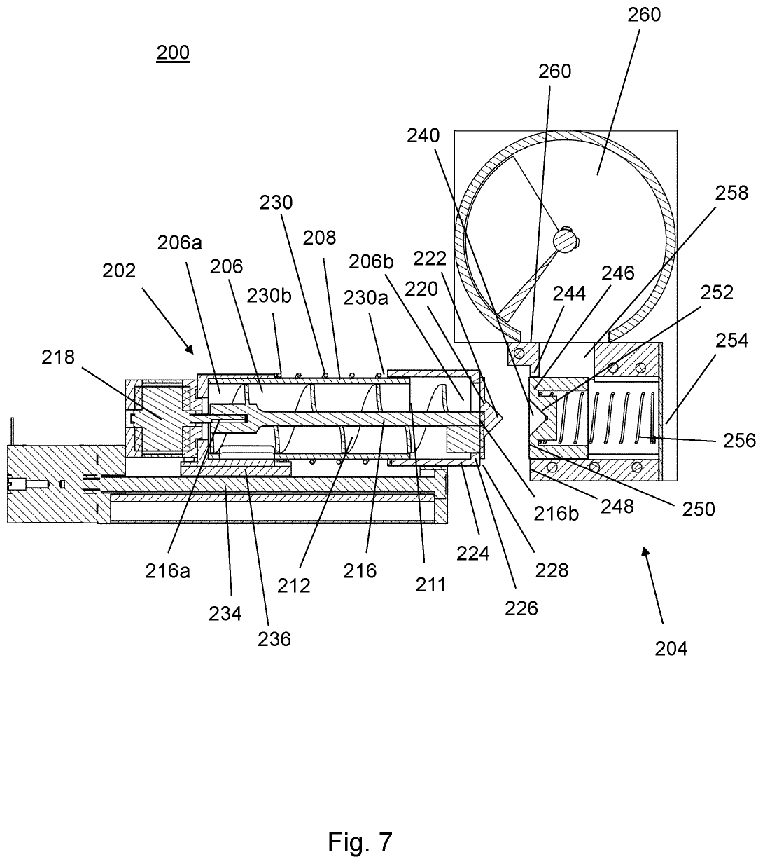

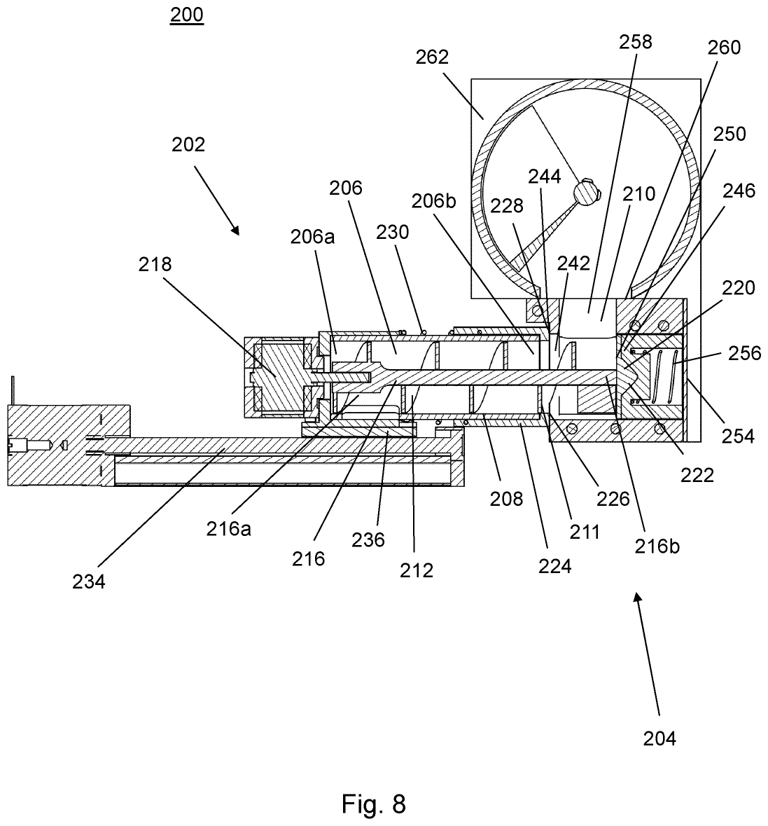

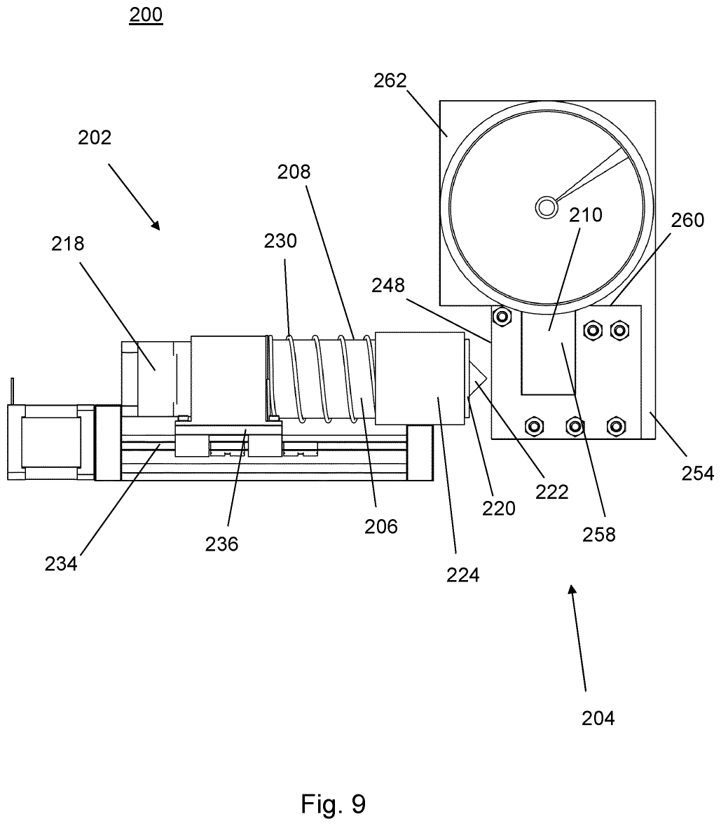

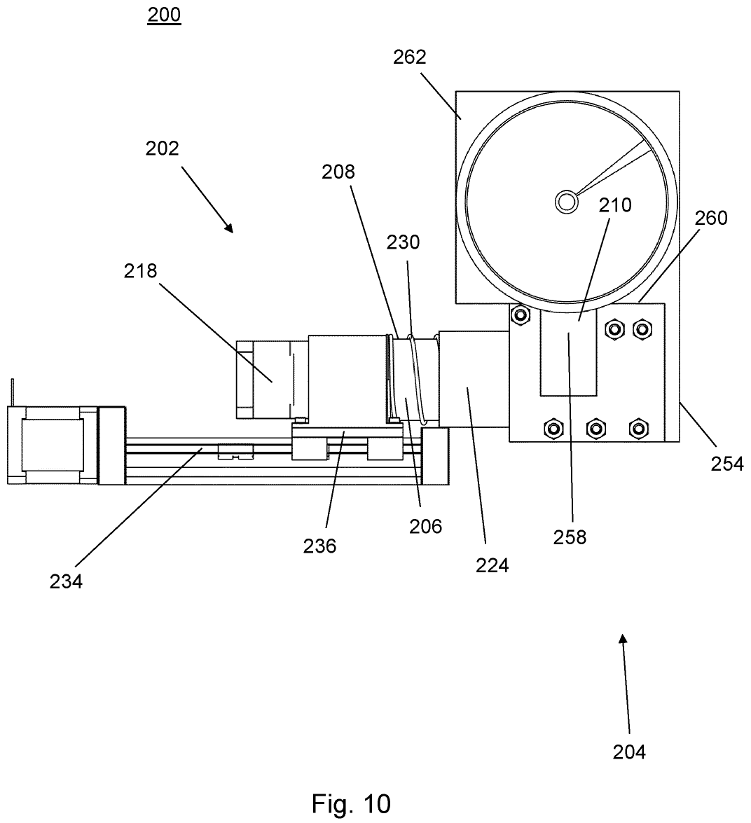

The outer sleeve 224 is movable between a closed position in which the outlet 210 is sealed and an open position in which the outlet 210 is open to permit discharge of granular material from the transport chamber 206. The outer sleeve 224 is actuated from the closed position to the open position by retracting the outer sleeve in the longitudinal direction away from the end cap 220 to uncover the outlet 210. FIGS. 7 and 9 show a side view of the granular material transfer apparatus with the outer sleeve 224 configured in the closed position. FIG. 7 is a cross sectional view while FIG. 9 is a schematic illustration. FIGS. 8 and 10 show a side view of the granular material transfer apparatus with the outer sleeve 224 configured in the open position. FIG. 8 is a cross sectional view while FIG. 10 is a schematic illustration.

The outer sleeve 224 comprises an annular flange 226 which extends inwardly from a circumferential edge 228 of the sleeve 224 towards the longitudinal axis 209, the annular flange 226 circumscribing the auger 212. The annular flange 226 has an inner diameter which is greater than an outer diameter of the auger 212 so the annular flange 226 is movable clear of the auger 212. The annular flange 226 overlaps the circumferential edge 211 of the peripheral wall 208 which abuts the annular flange 226 in the open position.

The annular flange 226 is configured to abut the end cap 220 in the closed position and therefore provides an interface between the peripheral wall 208 and the end cap 220. Hence, the inner diameter of the annular flange 226 is less than an outer diameter of the end cap 220. In the closed position, the outer sleeve 224 forms a seal with the end cap 220.

The filling module 202 comprises a biasing element 230 provided by a compression spring having a first end 230a coupled to the outer sleeve 224 and a second end 230b coupled to the transport chamber 206 to bias the outer sleeve 224 towards the closed position. The compression spring 230 is coiled around the peripheral wall 208 of the transport chamber 206 and has a central axis (not shown) coincident with the longitudinal axis 209 (see FIGS. 9 and 10). Retracting the outer sleeve 224 from the closed position to the open position therefore requires an opposing force to overcome the biasing force of the compression spring 230.

The transport chamber 206 is mounted to a guide rail 234 which defines a linear path of the transport chamber 206 for assisting coupling the filling module 202 to the receiving module 204. The linear path is configured parallel to the longitudinal direction. The guide rail 234 is slidably coupled to the transport chamber 206 by a slider 236 which is rigidly coupled to the transport chamber 206 and slidably coupled to the guide rail 234. In other embodiments (not shown), the transport chamber 206 may be freely movable during the step of coupling the filling module 202 to the receiving module 204 (i.e. without being mounted to a guide rail). For example, the transport chamber 206 may be transported manually, e.g. by hand. The transport chamber 206 may be transported using a vehicle (not shown) controlled remotely and/or locally. Alternatively, or additionally, the transport chamber 206 may be controlled using a robotic arm (not shown).

The conical shape of the nose portion 222 assists coupling of the filling module 202 to the receiving module 204 by locating the nose portion 222 at a complementary port 240 of the receiving module 204. In some embodiments (not shown), the annular flange 226 is frustoconical-shaped, having a cross-section perpendicular to the longitudinal axis 209 which converges in the longitudinal direction towards the end cap 220.

The complementary port 240 comprises an aperture 242 defined by an outer rim 244. As depicted in FIG. 8, the outer rim 244 is configured to abut the annular flange 226 of the outer sleeve 224 when coupling the filling module 202 to the receiving module 204 to provide a seal therebetween. In embodiments where the annular flange 226 is frustoconical-shaped, the outer rim 244 may comprise a complementary frustoconical interior surface (not shown).

The complementary port 240 is moveable between a closed position in which the receiving module 204 is sealed and an open position in which the receiving module 204 is capable of receiving granular material from the filling module 202. The complementary port 240 is moved to the open position by the relative movement between the filling module 202 and the receiving module 204. As shown in FIG. 8, the relative movement between the filling module 202 and the receiving module 204 involves the end cap 220 extending into the receiving module 204 through the aperture 242. Additionally, the auger 212 partially extends into the receiving module 202 in the open position. Hence, the aperture 242 comprises an inner diameter not less than the outer diameter of the end cap 220.

The complementary port 240 comprises a plug 246 for sealing the aperture 242 in the closed position (see FIG. 7). The complementary port 240 is formed in a front wall 248 of the receiving module 204 and the plug 246 is configured to abut the front wall 248 in the closed position. Specifically, the plug 246 is disposed within the receiving module 202 and is movable towards the open position inwardly and away from the front wall 248. The plug 246 comprises a plug shaft 248 extending along a plug axis (not shown) normal to the aperture 242. The plug 246 is configured to move along a linear path parallel to the plug axis.

The movement of the end cap 220 extending into the receiving module 204 displaces the plug 246 from its closed position. Therefore, the open position of the filling module 202 corresponds to the open position of the receiving module 204. The plug axis is aligned parallel to the longitudinal axis 209 when the filling module 202 is coupled to the receiving module 204 such that the plug 246 is movable in the longitudinal direction. The plug 246 comprises a front surface 250 exposed to the outside of the receiving module 204 in the closed position. The front surface 250 is configured to abut the end cap 220 by receiving the nose portion 222 in a conical recess 252.

Decoupling the filling module 202 from the receiving module 204 involves moving the transport chamber 206 away from the receiving module 204 thereby withdrawing the end cap 220 from the complementary port 240. The plug 246 is coupled to an inner wall 254 of the receiving module 204. The inner wall 254 is a rear wall opposite the front wall 248. The receiving module 204 comprises a second biasing element 256 provided by a second compression spring coupled to the plug 246 and the inner wall 254 and configured therebetween to bias the plug 246 towards the closed position. Therefore, the closed position of the filling module 202 corresponds to the closed position of the receiving module 204.

The receiving module 204 comprises an outlet 258 for permitting discharge of the granular material from the receiving module 204. The receiving module outlet 258 is formed in a side wall 260 of the receiving module 204 extending between the front wall 248 and the rear wall 254. The receiving module outlet 258 is arranged perpendicularly with respect to the complementary port 240. As shown in FIG. 8, the plug 246 is movable clear of the receiving module outlet 258 which is configured opposite the auger 212 in the open position.

The receiving module 204 is mountable to an external vessel 262 other than the filling module 202 for transferring granular material between the receiving module 204 and the external vessel 262 via the receiving module outlet 258. For example, the external vessel 262 may correspond to the supply chamber 150 of the granular material conveyance apparatus 100.

The apparatus 200 may be used according to the following steps. Firstly, the filling module 202 should be configured with respect to the receiving module 204 by orientating the filling module 202 to have the end cap 220 of the filling module 202 facing opposite the complementary port 240. Also, the longitudinal axis 209 of the transport chamber 206 should be approximately aligned with the plug axis.

By moving the transport chamber 206 towards the receiving module 204 along the linear path defined by the guide rail 234, the nose portion 222 of the end cap 220 is designed to locate the conical recess 252 in the front surface 250 of the plug 246. An abutment between the annular flange 226 and the outer rim 244 provides a seal to prevent leakage of granular material from the apparatus 200 and to avoid contaminants entering the conveyance path 214 from outside the filling module 202 and receiving module 204. In some embodiments, the frustoconical annular flange 226 and the complementary frustoconical outer rim 244 are designed to assist locating the nose portion 222 in the conical recess 252 and to provide an enhanced seal between the filling module 202 and the receiving module 204.

After the seal is formed between the annular flange and the front wall 248, the linear movement of the transport chamber 206 continues and the end cap 220 pushes the plug 246 front its closed position to its open position. The end cap 210 and the auger 212 subsequently extend through the aperture 242 while the outer sleeve 224 retracts relative to the end cap 210 to uncover the outlet 210. Therefore, the filling module 202 and the receiving module 204 both occupy the respective open positions.

In this configuration, driving the rotation of the auger 212 in the first rotation direction to convey granular material through the transport chamber 206 towards the outlet 210 of the filling module 202 causes the granular material to be discharged into the receiving module 204. Alternatively, driving the rotation of the auger 212 in the second rotation direction (opposite the first rotation direction) conveys the granular material within the transport chamber 206 away from the outlet 210 to extract granular material from the receiving module 204.

When the discharging/extraction phase has been completed, the rotation of the auger 212 may be stopped and the filling module 202 is decoupled from the receiving module 204 by moving the transport chamber 206 away from the complementary port 240. The compression spring 230 ensures that the outer sleeve 224 moves from the open position to the closed position as the end cap 210 is withdrawn from the receiving module 204, while also maintaining the seal between the annular flange 226 and the front wall 248. Simultaneously, the second compression spring 256 ensures that the plug 246 moves from the open position to the closed position as the end cap 210 is withdrawn from the receiving module 204 to prevent subsequent leakage of granular material from the receiving module 204.

When the outer sleeve 224 and the plug return to the respective closed positions, the linear movement of the transport chamber 206 continues and the filling module 202 completely separates from the receiving module 204.

Advantageously, this method preserves a controlled environment for the granular material during the transfer of granular material between the filling module 202 and the receiving module 204. Contamination of the granular material is thus avoided, even while the granular material is being transferred.

The granular material may comprise thermoplastic pellets (not shown) and the receiving module 204 or external vessel 260 may comprise a supply chamber for a 3D printing device (not shown). The apparatus 200 can therefore transport the thermoplastic pellets to the 3D printer and subsequently transfer the thermoplastic pellets to the 3D printer in an isolated environment to avoid contamination of the thermoplastic pellets. The apparatus 200 does not rely on the assistance of gravity to convey or discharge granular material. This makes the apparatus 200 particularly well-suited to applications in microgravity environments, e.g. for in-space manufacturing. It is particularly useful to be able to transport thermoplastic pellets to a 3D printer in space as and when the feedstock is required, while the 3D printer is maintained in space.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### LIST OF REFERENCE NUMBERS

100 granular material conveyance apparatus
102 discharge conduit
102a proximal end of discharge conduit
102b distal end of discharge conduit
104 elongate slot
106 conveyor
106a auger rotation axis
108 conveyance path
109 motor
110 end effector
112 end effector inlet
114 adjustable barrier
116 first section of spring tape
116a first end of first section
116b second end of first section
118 second section of spring tape
118a first end of second section
118b second end of second section
120 upper surface of adjustable barrier
122 lower surface of adjustable barrier
123 inner surface of discharge conduit
124 first extension and retraction mechanism
126 second extension and retraction mechanism
128 first wheel
130 second wheel
132 first outer casing
134 second outer casing
136 slider
137 outer surface of discharge conduit
138 first longitudinal edge
140 second longitudinal edge
138a first groove
140a second groove
142 first longitudinal groove of slider
144 second longitudinal groove of slider
146 central platform
150 supply chamber
150a proximal end of supply chamber
150b distal end of supply chamber
152 inlet of supply chamber
154 outlet of supply chamber
156 platform
158 second conveyor
160 second conveyance path
162 rotatable joint
163 circumferential surface
164 second auger rotation axis
166 first bearing
168 peripheral wall of supply chamber
170 second bearing
200 granular material transfer apparatus
202 filling module
204 receiving module
206 transport chamber
206a proximal end of transport chamber
206b distal end of transport chamber
208 peripheral wall
209 longitudinal axis
210 outlet
211 circumferential edge of peripheral wall
212 conveyor
212a rotation axis
214 conveyance path
216 shaft
216a first end of shaft
216b second end of shaft
218 motor
220 end cap
220a end cap rotation axis
222 nose portion
224 cover
226 annular flange
228 circumferential edge of outer sleeve
230 biasing element
230a first end of spring
230b second end of spring
234 guide rail
236 slide
240 complementary port
242 aperture
244 outer rim
246 plug
248 front wall
250 front surface
252 conical recess
254 rear wall
256 second biasing element
258 receiving module outlet
260 side wall
262 external vessel

### REFERENCES

A number of publications are cited above in order to more fully describe and disclose the invention and the state of the art to which the invention pertains. Full citations for these references are provided below. The entirety of each of these references is incorporated herein.
[1] Costantino, Greg; DiVencenzo, Zac. “3D Printing with Fused Filament Fabrication and Fused Granulate Fabrication (Pellet Printing)”, (accessed Sep. 26, 2022). Accessed from https://am.covestro.com/en_US/insights/blog/3d-printing-with-fused-filament-fabrication-and-fused-granulate-fabrication.html.
[2] Data sheets from datasheet4u [Online] Available: https://www.datasheet4u.com/datasheet-pdf/MotionKing/17HS4401/pdf.php?id=928661 (accessed 12 October 2022)

1. A granular material conveyance apparatus, the apparatus comprising:
a discharge conduit comprising a proximal end configured to receive granular material from a granular material source and a distal end separated from the proximal end along a longitudinal direction of the conduit, wherein the discharge conduit is movable with respect to the granular material source,
an end effector engaged externally with respect to the discharge conduit so as to be translatable along the longitudinal direction of the discharge conduit,
wherein the discharge conduit further comprises a conveyor configured to move the granular material along a conveyance path disposed within the discharge conduit from the proximal end towards the distal end of the discharge conduit,
wherein the end effector has an inlet in communication with the conveyance path at least at a plurality of positions of the end effector with respect to the discharge conduit to allow the granular material to be conveyed from the discharge conduit and into the end effector.

2. An apparatus according to claim 1, wherein the inlet of the end effector is in communication with the conveyance path continuously during translation of the end effector along the longitudinal direction of the discharge conduit.

3. An apparatus according to claim 2, wherein the discharge conduit comprises an elongate slot extending between the proximal end and the distal end, the elongate slot configured to permit discharge of the granular material therethrough to the inlet.

4. An apparatus according to claim 3, wherein the discharge conduit comprises an adjustable barrier configured to prevent discharge of the granular material from the elongate slot at locations other than the location of the inlet of the end effector.

5. An apparatus according to claim 4, wherein the adjustable barrier is reversibly extendable with respect to the end effector.

6. An apparatus according to claim 5, further comprising a first extension and retraction mechanism coupled to a first end of the adjustable barrier and configured to pay out and store the adjustable barrier along the longitudinal direction.

7. An apparatus according to claim 6, further comprising a second extension and retraction mechanism coupled to a second end of the adjustable barrier and configured to pay out and store the adjustable barrier along the longitudinal direction in concert with the first extension and retraction mechanism.

8. An apparatus according to claim 7, wherein the adjustable barrier comprises a tape, the tape being configured to extend along the slot of the discharge conduit and to be coiled within the first and second extension and retraction mechanisms.

9. An apparatus according to any one of claims 1 to 8, wherein the discharge conduit is configured to receive granular material from the granular material source via a supply chamber having an outlet in communication with the proximal end of the discharge conduit and configured to contain granular material.

10. An apparatus according to claim 9, wherein the discharge conduit is coupled to the supply chamber via a rotatable joint, the rotatable joint configured to permit swinging of the discharge conduit with respect to the supply chamber.

11. An apparatus according to claim 10, wherein the outlet of the supply chamber is disposed at a distal end of the supply chamber, the distal end of the supply chamber separated from a proximal end of the supply chamber along a second longitudinal direction,
wherein the supply chamber comprises a second conveyor configured to move the granular material along a second conveyance path disposed within the supply chamber from the proximal end of the supply chamber towards the distal end of the supply chamber.

12. A system for handling granular material, the system comprising a granular material conveyance apparatus according to any preceding claim and a granular material transfer apparatus,
wherein the granular material transfer apparatus comprises a filling module and a receiving module, the filling module being configured to be received by the receiving module to transfer granular material between the filling module and the receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet from the transport chamber is sealed and an open position in which the outlet from the transport chamber is open to permit discharge of granular material from the transport chamber,
wherein the granular material source for the granular material conveyance apparatus is provided by the receiving module of the granular material transfer apparatus.

13. A method of transferring granular material between a filling module and a receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet is sealed and an open position in which the outlet is open to permit discharge of granular material from the transport chamber,
the method comprising steps of:
coupling the filling module to the receiving module;
moving the cover from the closed position to the open position; and
operating the conveyor to transfer granular material between the transport chamber and the receiving module via the outlet.

14. A method according to claim 13 wherein the transport chamber has a peripheral wall surrounding the conveyance path and wherein the outlet is formed in the peripheral wall.

15. A method according to claim 14, wherein the cover comprises a sleeve moveable with respect to the peripheral wall of the transport chamber between the closed position and the open position.

16. A method according to claim 15, wherein the filling module further comprises an end cap, wherein the sleeve is movable with respect to the end cap and configured to form a seal with the end cap in the closed position.

17. A method according to claim 16 wherein the step of coupling the filling module to the receiving module comprises the end cap of the filling module fitting to a complementary port on the receiving module and wherein the step of moving the cover from the closed position to the open position comprises a subsequent relative movement between the filling module and the receiving module.

18. A method according to claim 17 wherein the complementary port on the receiving module is moveable between a closed position in which the receiving module is sealed and an open position in which the receiving module is capable of receiving granular material from the filling module, wherein the complementary port on the receiving module is moved to the open position by said subsequent relative movement between the filling module and the receiving module.

19. A method according to any one of claims 13 to 18 further comprising the step of:
decoupling the filling module from the receiving module;
wherein decoupling the filling module from the receiving module causes movement of the cover from the open position to the closed position to seal the outlet of the transport chamber.

20. A granular material transfer apparatus, the apparatus comprising a filling module and a receiving module, the filling module being configured to be received by the receiving module to transfer granular material between the filling module and the receiving module, the filling module comprising:
a transport chamber configured to store granular material;
a conveyor disposed in the transport chamber and configured to move the granular material along a conveyance path to an outlet of the transport chamber; and
a cover disposed with respect to the transport chamber and movable between a closed position in which the outlet from the transport chamber is sealed and an open position in which the outlet from the transport chamber is open to permit discharge of granular material from the transport chamber.

21. A system for handling granular material, the system comprising a granular material transfer apparatus according to claim 20 and a granular material conveyance apparatus,
wherein the granular material conveyance apparatus comprises:
a discharge conduit comprising a proximal end configured to receive granular material from a granular material source and a distal end separated from the proximal end along a longitudinal direction of the conduit, wherein the discharge conduit is movable with respect to the granular material source,
an end effector engaged externally with respect to the discharge conduit so as to be translatable along the longitudinal direction of the discharge conduit,
wherein the discharge conduit further comprises a conveyor configured to move the granular material along a conveyance path disposed within the discharge conduit from the proximal end towards the distal end of the discharge conduit,
wherein the end effector has an inlet in communication with the conveyance path at least at a plurality of positions of the end effector with respect to the discharge conduit to allow the granular material to be conveyed from the discharge conduit and into the end effector,
wherein the granular material source for the granular material conveyance apparatus is provided by the receiving module of the granular material transfer apparatus.
